(19) United States
(12) Patent Application Publication
(10) Pub. No.: US 2021/0107529 A1
(43) Pub. Date: Apr. 15, 2021

(54) VEHICLE CONTROL SYSTEM, VEHICLE CONTROL METHOD, AND PROGRAM

(71) Applicant: HONDA MOTOR CO., LTD., Minato-ku, Tokyo (JP)

(72) Inventors: Takafumi Hirose, Wako-shi (JP); Naoto Yasuda, Wako-shi (JP); Yuki Oshitani, Tokyo (JP); Susumu Iwamoto, Tokyo (JP)

(21) Appl. No.: 16/970,409

(22) PCT Filed: Feb. 20, 2019
(86) PCT No.: PCT/JP2019/006274

§ 371 Date: Aug. 17, 2020

(30) Foreign Application Priority Data
Feb. 22, 2018 (JP) 2018-029731

(51) Int. Cl. B60W 60/00; B60W 30/06; G01C 21/34; B60Q 1/50; G08G 1/123; G06Q 50/30; G06Q 10/06; G06Q 30/04; G06Q 30/02; G07B 15/02; G06Q 10/02; G06Q 50/06; G06Q 10/04

(52) U.S. Cl. CPC B60W 60/00253; G06Q 2240/00; G01C 21/3453; B60Q 1/50; G08G 1/123; G06Q 50/30; G06Q 10/06315; G06Q 30/04; G06Q 30/0284; G07B 15/02; G06Q 10/02; G06Q 50/06; G06Q 10/047; B60W 2420/40; B60W 2420/52; B60W 30/06

(57) ABSTRACT

Provided is a vehicle control system including a reception unit (30, 20, 510) that receives setting of a use schedule of an automatic driving vehicle by a user, and a control unit (146, 520) that causes the automatic driving vehicle to travel as a taxi from a starting time of a period in which the user does not use the automatic driving vehicle to a termination time and causes the automatic driving vehicle to travel so that the automatic driving vehicle returns to a location designated by the user by the termination time, with reference to the use schedule received by the reception unit.

### TECHNICAL FIELD

The present invention relates to a vehicle control system, a vehicle control method, and a program.

Priority is claimed on Japanese Patent Application No. 2018-029731, filed Feb. 22, 2018, the content of which is incorporated herein by reference.

### BACKGROUND ART

In recent years, research on automatic control of a vehicle has been carried out. For example, a system that provides a service for allowing a plurality of persons to be able to use an automatic driving vehicle by managing a schedule and identification information of a user has become known (see, for example, Patent Literature 1).

### CITATION LIST

### Patent Literature

[Patent Literature 1]

Japanese Unexamined Patent Application, First Publication No. 2017-191371

### SUMMARY OF INVENTION

### Technical Problem

However, in some cases, an automatic driving vehicle may not be able to be used sufficiently with only a user who has registered identification information in advance.

The present invention is contrived in view of such circumstances, and an object thereof is to provide a vehicle control system, a vehicle control method, and a program which allow a user other than an owner to widely use an automatic driving vehicle.

### Solution to Problem

A vehicle control system, a vehicle control method, and a program according to the invention adopt the following configurations.

(1) A vehicle control system according to an aspect of the invention is a vehicle control system including a reception unit configured to receive setting of a use schedule of an automatic driving vehicle by a user, and a control unit configured to cause the automatic driving vehicle to travel as a taxi from a starting time to a termination time of a period in which the user does not use the automatic driving vehicle and cause the automatic driving vehicle to travel so that the automatic driving vehicle returns to a location designated by the user by the termination time, with reference to the use schedule received by the reception unit.

(2) In the aspect of (1), the control unit causes the automatic driving vehicle to travel to an appointment location for a customer on the basis of a vehicle allocation request received by the customer, and causes the automatic driving vehicle to pick up the customer and then travel to a destination desired by the customer.

(3) In the aspect of (1), the control unit executes billing processing of a traveling fare in a case where the automatic driving vehicle is traveling as a taxi.

(4) In the aspect of (1), the control unit allocates an automatic driving vehicle matching a vehicle allocation request received by a customer among a plurality of automatic driving vehicles registered in advance, with reference to the use schedule.

(5) In the aspect of (1), the control unit executes notification processing for visually giving notice indicating that the automatic driving vehicle is traveling as a taxi.

(6) In the aspect of (1), the control unit creates a most efficient traveling plan on the basis of a fare obtained in a case where the automatic driving vehicle has traveled as a taxi and a fare of energy consumed due to traveling of the automatic driving vehicle.

(7) In the aspect of (1), the control unit derives a taxi termination time for the automatic driving vehicle to return to a location designated by the user by the termination time in a case where the automatic driving vehicle is traveling as a taxi, and causes the automatic driving vehicle to terminate traveling as a taxi when the taxi termination time has arrived and travel toward the location designated by the user.

(8) In the aspect of (1), the vehicle control system further includes a recognition unit configured to recognize a situation in a vicinity of the automatic driving vehicle, in which the control unit detects a customer on the basis of a recognition result obtained by the recognition unit and causes the automatic driving vehicle to stop near the detected customer in a case where the customer has been detected.

(9) In the aspect of (1), the control unit retrieves a parking space in a case where a period in which the automatic driving vehicle is not able to continuously pick up a customer in a state where the automatic driving vehicle is traveling as a taxi exceeds a threshold value, and causes the automatic driving vehicle to travel toward the parking space obtained through the retrieval.

(10) In the aspect of (1), the control unit preferentially selects a route in which the automatic driving vehicle is able to travel at a low automatic driving level to cause the automatic driving vehicle to travel.

(11) In the aspect of (1), the control unit limits a location to be designated by a customer in a case where the automatic driving vehicle travels as a taxi.

(12) In the aspect of (1), the control unit executes processing for causing a customer to transfer to another vehicle traveling as a taxi in a case where the automatic driving vehicle travels as a taxi and a case where a location designated by the customer is outside a travelable area.

(13) In the aspect of (1), the control unit is included in at least one of an in-vehicle device mounted in the automatic driving vehicle or a management device communicating with the in-vehicle device.

(14) A vehicle control method according to another aspect of the invention is a vehicle control method including causing one or more computers to receive setting of a use schedule of an automatic driving vehicle by a user, and cause the automatic driving vehicle to travel as a taxi from a starting time to a termination time of a period in which the user does not use the automatic driving vehicle and cause the automatic driving vehicle to travel so that the automatic driving vehicle returns to a location designated by the user by the termination time, with reference to the received use schedule.

(15) A program according to still another aspect of the invention is a program causing one or more computers to receive setting of a use schedule of an automatic driving vehicle by a user, and cause the automatic driving vehicle to travel as a taxi from a starting time to a termination time of a period in which the user does not use the automatic driving vehicle and cause the automatic driving vehicle to travel so that the automatic driving vehicle returns to a location designated by the user by the termination time, with reference to the received use schedule.

### Advantageous Effects of Invention

According to the above-described aspects of (1) to (15), it is possible to cause a user other than an owner to widely use an automatic driving vehicle.

### BRIEF DESCRIPTION OF DRAWINGS

FIG. 1 is a configuration diagram of a vehicle control system 1 according to an embodiment.

FIG. 2 is a configuration diagram of a management device 500.

FIG. 3 is a diagram showing an example of contents of schedule information 532.

FIG. 4 is a diagram showing an example of contents of taxi traveling condition information 534.

FIG. 5 is a diagram showing an example of contents of positional information 536.

FIG. 6 is a diagram showing an example of contents of vehicle status information 538.

FIG. 7 is a configuration diagram of a vehicle control device 5 according to the embodiment.

FIG. 8 is a functional configuration diagram of a first control unit 120 and a second control unit 160.

FIG. 9 is a sequence diagram showing an example of a flow of a series of processes performed by the vehicle control system 1 of the embodiment.

FIG. 10 is a flowchart showing an example of a flow of processing performed by the management device 500.

FIG. 11 is a flowchart showing an example of a flow of processing performed by a taxi control unit 146.

FIG. 12 is a flowchart showing another example of a flow of processing performed by the taxi control unit 146.

FIG. 13 is a flowchart showing still another example of a flow of processing performed by the taxi control unit 146.

FIG. 14 is a diagram showing an example of a hardware configuration of an automatic driving control device 100 of the embodiment.

### DESCRIPTION OF EMBODIMENTS

Hereinafter, embodiments of a vehicle control system, a vehicle control method, and a program will be described with reference to the accompanying drawings.

[Overall Configuration]

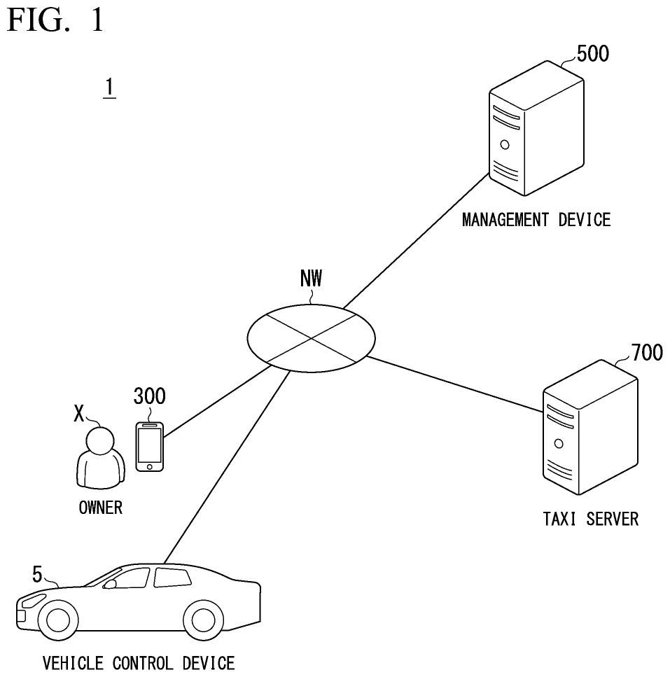

FIG. 1 is a configuration diagram of a vehicle control system 1 according to an embodiment. The vehicle control system 1 is realized by one or more processors (computers). The vehicle control system 1 includes, for example, one or more vehicle control devices 5, one or more terminal devices 300, a management device 500, and a taxi server 700. The vehicle control device 5 is an in-vehicle device which is mounted on an automatic driving vehicle having an automatic driving function. The automatic driving vehicle is, for example, a private vehicle of an owner X. The terminal device 300 is a terminal device owned by the owner X, and is a portable terminal device having at least a communication function and a function of inputting and outputting information, for example, a mobile phone such as a smartphone, a tablet terminal, a notebook computer, or a personal digital assistant (PDA).

The taxi server 700 is a server operated by a business operator such as a taxi company, and receives information regarding a vehicle allocation request, and the like from a customer and provides various services related to a taxi. The taxi server 700 instructs the management device 500 to allocate an automatic driving vehicle in response to the vehicle allocation request received from the customer. For example, the taxi server 700 transmits the information (for example, a call location, an appointment time, the number of reserved persons, a destination, and the like) regarding the vehicle allocation request received from the customer to the management device 500 and instructs the management device to allocate a vehicle. The call location is a location where a taxi picks up a customer. The taxi server 700 may transmit information indicating an area in which a customer is likely to be picked up in the case of traveling by a cruising taxi or an area in which a taxi is insufficient to the management device 500.

The vehicle control device 5, the terminal device 300, the management device 500, and the taxi server 700 are connected to each other through a network NW and communicate with each other through the network NW. The network NW includes some or all of, for example, a wide area network (WAN), a local area network (LAN), the Internet, a dedicated line, a wireless base station, a provider, and the like.

Here, an example of a use scene of the vehicle control system 1 according to the embodiment will be described. For example, it is assumed that the owner X gets on an automatic driving vehicle, departs from home, and arrives at a shopping mall which is a destination before noon. The owner X is scheduled to stay in the shopping mall until evening. In such a scene, the owner X can cause the automatic driving vehicle to travel as a taxi from the time the owner arrives at the shopping mall to the time the owner returns. The owner X sets a use time and a return point as traveling conditions of the taxi using, for example, the terminal device 300.

For example, the use time is a time from 10 a.m. to 5 p.m., and the return point is the shopping mall. The vehicle control system 1 causes the automatic driving vehicle to travel as a taxi so that the automatic driving vehicle returns to the shopping mall by 5 p.m. The use scene is not limited thereto, and the automatic driving vehicle can also be used as a taxi in a period during which the automatic driving vehicle is not used by the owner X, for example, during the day on a weekday or during the night on the weekend. In this case, a return point is the owner X's home or the like.

[Management Device 500]

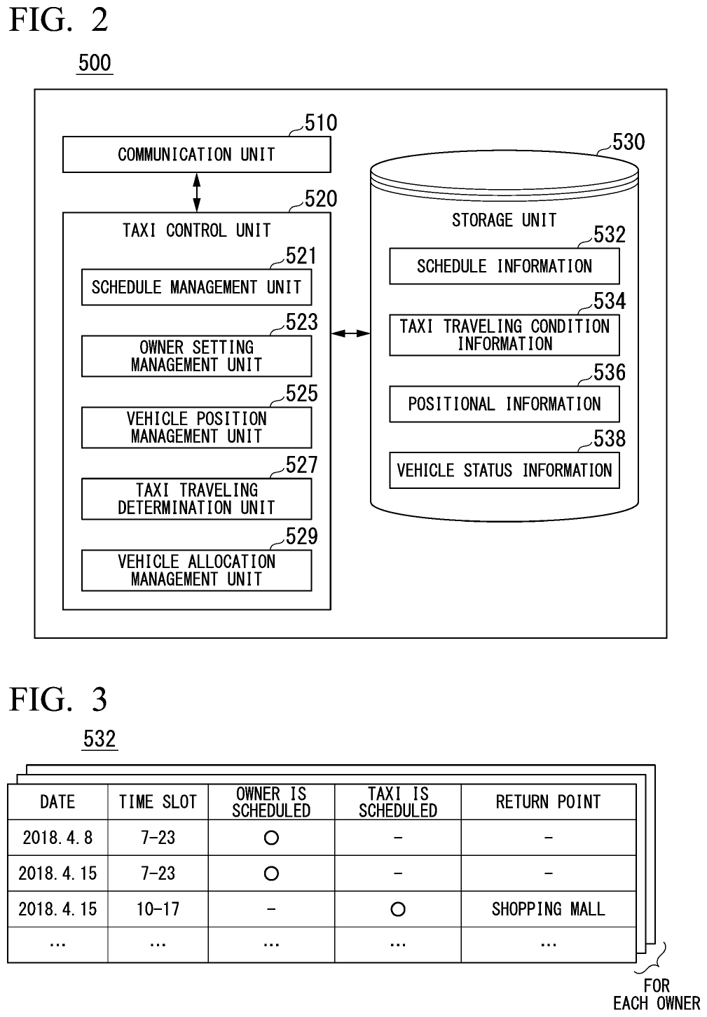

First, the management device 500 will be described. FIG. 2 is a configuration diagram of the management device 500. The management device 500 includes a communication unit 510, a taxi control unit 520, and a storage unit 530.

The communication unit 510 includes a communication interface such as an NIC. The storage unit 530 is, for example, a random access memory (RAM), a read only memory (ROM), a flash memory such as a solid state drive (SSD), a hard disk drive (HDD), or the like. Information such as schedule information 532, taxi traveling condition information 534, positional information 536, and vehicle status information 538 is stored in the storage unit 530. The storage unit 530 may be an external storage device such as a network attached storage (NAS) that can be accessed by the management device 500 through a network.

The schedule information 532 is information indicating a use schedule of the automatic driving vehicle. FIG. 3 is a diagram showing an example of contents of the schedule information 532. As shown in FIG. 3, the schedule information 532 is information in which a time slot, an owner schedule, and a taxi schedule are associated with a date. A table as shown in FIG. 3 is prepared for each owner. The date and the time slot are a date and time when a schedule of use of the automatic driving vehicle is set. In a case where the automatic driving vehicle is scheduled to be used by the owner, “○” indicating that “a schedule has been set” is described in the column of the owner schedule. In a case where the automatic driving vehicle is scheduled to be used as a taxi, “○” indicating that “a schedule has been set” is described in the column of the taxi schedule. In addition, “−” described in the column of the owner schedule and the column of the taxi schedule indicates that a schedule has not been set. The use schedule may be set by the owner X, or may be set by the management device 500 on the basis of the use schedule and taxi traveling conditions which are set by the owner X.

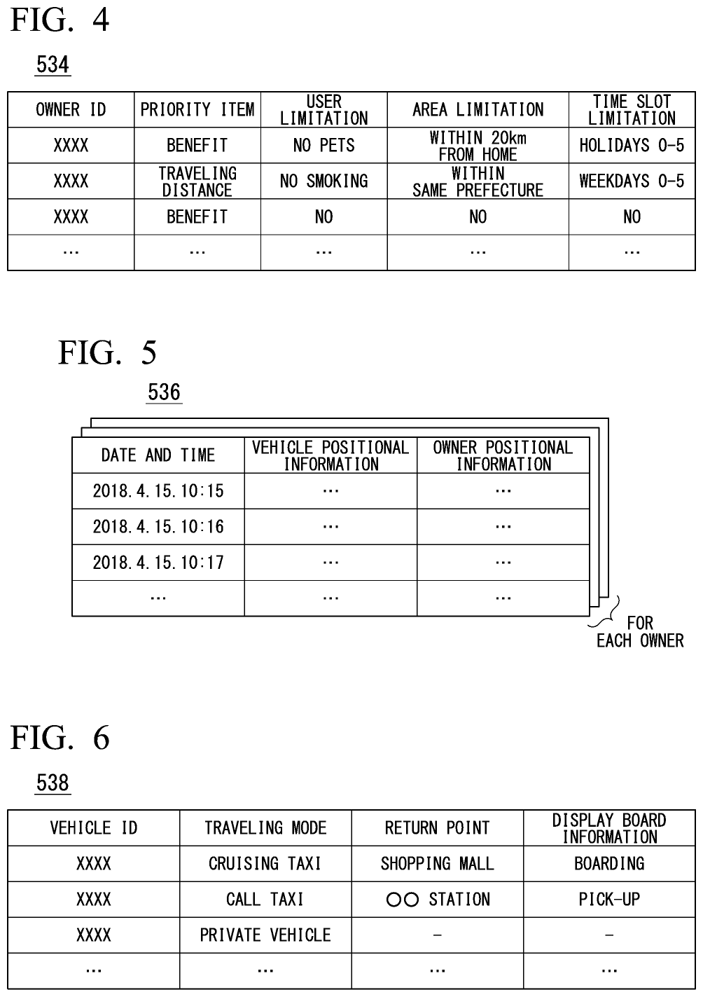

The taxi traveling condition information 534 is information indicating the taxi traveling conditions which are set by the owner X. FIG. 4 is a diagram showing an example of contents of the taxi traveling condition information 534. As shown in FIG. 4, the taxi traveling condition information 534 is information in which a priority item, a user limitation, an area limitation, and a time slot limitation are associated with an owner ID. The owner ID is identification information for identifying each owner. The priority item is an item having the highest priority when the automatic driving vehicle is used as a taxi. The user limitation indicates a limitation on a customer who gets on the automatic driving vehicle. The area limitation indicates an area where the automatic driving vehicle can travel when traveling as a taxi. The time slot limitation indicates a time slot in which the automatic driving vehicle can travel as a taxi.

The positional information 536 is information indicating the position of the automatic driving vehicle. FIG. 5 is a diagram showing an example of contents of the positional information 536. As shown in FIG. 5, the positional information 536 is information in which vehicle positional information and owner positional information are associated with a date and time. The vehicle positional information is information indicating the position of the automatic driving vehicle which is acquired by the navigation device 50. The owner positional information is information indicating the position of the terminal device 300 which is acquired using a GNSS of the terminal device 300 owned by the owner X, or the like.

The vehicle status information 538 is information indicating the state of each automatic driving vehicle. FIG. 6 is a diagram showing an example of contents of the vehicle status information 538. As shown in FIG. 6, the vehicle status information 538 is information in which a traveling mode, a return point, and display board information are associated with a vehicle ID. The vehicle ID is identification information for identifying each automatic driving vehicle. The traveling mode is a traveling mode of the automatic driving vehicle, and includes, for example, a cruising taxi, a call taxi, a private vehicle, and the like. Details of the traveling mode will be described later. The return point is one of taxi traveling conditions which are set by the owner X, and is a location where the automatic driving vehicle returns after traveling as a taxi. The display board information is information which is displayed on a display board provided at a position where the automatic driving vehicle is visible to an outside person when traveling as a taxi, and includes, for example, boarding, getting-off, picking-up, and the like.

The taxi control unit 520 includes a schedule management unit 521, an owner setting management unit 523, a vehicle position management unit 525, a taxi traveling determination unit 527, and a vehicle allocation management unit 529. Some or all of these components are realized by a processor such as a central processing unit (CPU) executing programs (software) stored in the storage unit 550. Some or all of the functions of these components may be realized by hardware (a circuit unit; circuitry is included) such as a large scale integration (LSI), an application specific integrated circuit (ASIC), a field-programmable gate array (FPGA), or a graphics processing unit (GPU), or may be realized by cooperation of software and hardware. The programs may be stored in a storage unit such as an HDD or a flash memory of the taxi control unit 520 in advance, may be stored in a detachable storage medium such as a DVD or a CD-ROM, or may be installed by the HDD or the flash memory of the taxi control unit 520 by being mounted on a drive device.

The schedule management unit 521 updates the schedule information 532 on the basis of information received from the vehicle control device 5 or the terminal device 300 using the communication unit 510. The schedule management unit 521 may create a use schedule with reference to the schedule information 532 and the taxi traveling condition information 534 and may add the created use schedule to the schedule information 532. For example, the schedule management unit 521 creates a taxi schedule in a set time slot (for example, a period from 0 a.m. to 5 a.m. on a weekday) on the basis of time slot limitation of the taxi traveling condition information 534.

The owner setting management unit 523 updates the taxi traveling condition information 534 on the basis of information received from the terminal device 300 using the communication unit 510.

The vehicle position management unit 525 updates the positional information 536 on the basis of positional information received from the vehicle control device 5 using the communication unit 510. The vehicle position management unit 525 may update the positional information 536 on the basis of positional information received from the terminal device 300 using the communication unit 510.

The taxi traveling determination unit 527 determines a period in which an automatic driving vehicle travels as a taxi (hereinafter, a taxi traveling period) with reference to the schedule information 532. For example, the taxi traveling determination unit 527 determines a period in which the owner X does not use an automatic driving vehicle (for example, a period in which a schedule of the owner X is not included, and a period in which a schedule as a taxi is included by the owner X) in a use schedule of the automatic driving vehicle as a taxi traveling period. The taxi traveling period includes, for example, a night-time or a daytime on a weekday when the owner X does not use the automatic driving vehicle, or a period in which the owner X does not use the automatic driving vehicle while the owner is out (for example, a period from when the automatic driving vehicle arrives at the shopping mall to when the automatic driving vehicle returns). The taxi traveling determination unit 527 may determine a period meeting taxi traveling conditions among periods in which the owner X does not use the automatic driving vehicle to be a taxi traveling period with reference to the taxi traveling condition information 534.

The taxi traveling determination unit 527 derives a time at which a taxi is terminated (hereinafter, referred to as a taxi termination time) in order to return to a return point by a termination time of a taxi traveling period on the basis of a current time and the current position of the automatic driving vehicle in the taxi traveling period. The taxi traveling determination unit 527 transmits the derived taxi termination time to the vehicle control device 5. For example, the taxi traveling determination unit 527 sets a time obtained by calculating back a total time, obtained by adding a predetermined spare time to a time in a case where the automatic driving vehicle travels from the current position thereof (or a destination set by a customer of a taxi) to the return point, from the termination time of the taxi traveling period to be a taxi termination time. The taxi traveling determination unit 527 may derive the taxi termination time in consideration of congestion in a route to the return point, congestion in a route to the destination set by the taxi customer, or the like.

The taxi traveling determination unit 527 determines a traveling plan in the taxi traveling period. The traveling plan includes a traveling mode, a traveling schedule, a traveling route, and the like. The traveling mode includes a mode in which an automatic driving vehicle travels as a taxi on which a customer having raised a hand gets during traveling (hereinafter, a cruising taxi), a mode in which an automatic driving vehicle travels as a taxi going to pick up a customer to a call point designated by the customer (hereinafter, referred to as a call taxi), and the like. The traveling schedule includes a priority and a time of each traveling mode. The traveling route includes a traveling area (a center in front of a station, a center in the city), a priority road (a priority is given to a main street), and the like. The taxi traveling determination unit 527 may change a traveling plan with reference to the storage unit 530 during a taxi traveling period (that is, while the automatic driving vehicle travels as a taxi).

The taxi traveling determination unit 527 creates the most efficient traveling plan on the basis of, for example, a fare obtained in a case where an automatic driving vehicle travels as a taxi and a fee for energy consumed due to the traveling of the automatic driving vehicle. The taxi traveling determination unit 527 may periodically review the traveling plan and change the traveling plan to a more efficient traveling plan. For example, the taxi traveling determination unit 527 determines a traveling plan in accordance with the length of a taxi traveling period and a time slot. Specifically, in a case where a taxi traveling period is long, a traveling plan making it possible to execute both a cruising taxi and a call taxi is determined. In a case where a taxi traveling period is short, a traveling plan for switching an execution period of a cruising taxi and an execution period of a call taxi is determined for each predetermined period. In a case where it is predicted that the fare of energy consumed due to the traveling of the automatic driving vehicle is higher than the fare obtained in a case where the automatic driving vehicle travels as a taxi, the taxi traveling determination unit 527 changes the traveling plan to a traveling plan for temporarily stopping the automatic driving vehicle on a road shoulder (an area where stopping of a car is permitted) or parking the automatic driving vehicle in a parking lot (a space where the automatic driving vehicle can be parked, a parking space on a road where a parking meter is installed, and the like are included). The taxi traveling determination unit 527 creates a traveling plan for causing the automatic driving vehicle to travel by preferentially selecting a fuel-efficient road (for example, a straight road or a road which is not congested) in a case where the automatic driving vehicle travels as a cruising taxi or a route in which the automatic driving vehicle can travel with a low automatic driving level. The taxi traveling determination unit 527 creates a traveling plan for causing the automatic driving vehicle to travel in an area where customers are likely to be picked up, on the basis of information received from the taxi server 700. In a case where there are a plurality of vehicle allocation requests for one automatic driving vehicle, the taxi traveling determination unit 527 receives a vehicle allocation request on a route in which the automatic driving vehicle can efficiently travel.

The taxi traveling determination unit 527 may create a traveling plan by giving a priority to a priority item which is set by the owner X, with reference to the taxi traveling condition information 534. For example, in a case where the priority item is “benefit”, the taxi traveling determination unit 527 creates a traveling plan in which a value obtained by subtracting a fare of energy consumed due to the traveling of the automatic driving vehicle from a fare obtained in a case where the automatic driving vehicle travels as a taxi is maximized. In a case where the priority item is “traveling distance”, the taxi traveling determination unit 527 changes the traveling plan to a traveling plan for temporarily stopping the automatic driving vehicle on a road shoulder, parking the automatic driving vehicle in a parking lot, or returning the automatic driving vehicle to a return point in a case where a traveling distance as a cruising taxi exceeds a first threshold value or a case where a traveling distance as a call taxi exceeds a second threshold value. In a case where the priority item is “endurance of vehicle”, the taxi traveling determination unit 527 creates a traveling plan that avoids (or does not include) a route in which the automatic driving vehicle passes through a road with a slope, a route where a road is poorly paved, a route which is congested, and the like.

The taxi traveling determination unit 527 may create a traveling plan satisfying limitation conditions which are set by the owner X with reference to the taxi traveling condition information 534. The creating of the traveling plan satisfying limitation conditions includes, for example, setting a destination within the range of an area limitation, setting a destination allowing a return to a return point within the range of a time slot limitation, and the like. For example, in a case where a destination of a customer exceeds limitation conditions, a traveling plan to a destination satisfying limitation conditions may be created. In this case, the taxi traveling determination unit 527 may create a traveling plan including a fare discount coupon and other privileges.

The taxi traveling determination unit 527 updates the vehicle status information 538 on the basis of a determined traveling plan. In a case where the taxi traveling determination unit 527 has received a change in status from the vehicle control device 5, the taxi traveling determination unit updates the vehicle status information 538 on the basis of the received information.

The vehicle allocation management unit 529 retrieves an automatic driving vehicle matching a vehicle allocation request received from the taxi server 700 (or a customer) with reference to the storage unit 530, and transmits call information to the automatic driving vehicle obtained through the retrieval. The automatic driving vehicle matching the vehicle allocation request is a vehicle that satisfies, for example, vehicle allocation conditions among a plurality of automatic driving vehicles registered in the storage unit 530 in advance. The vehicle allocation conditions include, for example, the number of persons reserved being equal to or less than a fixed number, the automatic driving vehicle that can arrive at a call location by an appointment time, and the automatic driving vehicle that can return to a return point by a termination time of a taxi traveling period after traveling as a taxi to a destination. The vehicle allocation conditions may include satisfying traveling conditions of a taxi. The satisfying of the traveling conditions of the taxi includes, for example, a case where attributes of a customer who has called a taxi satisfy user limitations of taxi traveling conditions, a case where a destination is within the range of an area limitation, and the like.

Call information includes a call location, the number of persons reserved, a destination, customer attribute information (a smoker, a pet companion, or the like), an e-mail address of a customer, identification information allocated to a customer, a reservation number, and the like. The vehicle allocation management unit 529 generates call information on the basis of a vehicle allocation request received from the taxi server 700.

[Vehicle Control Device 5]

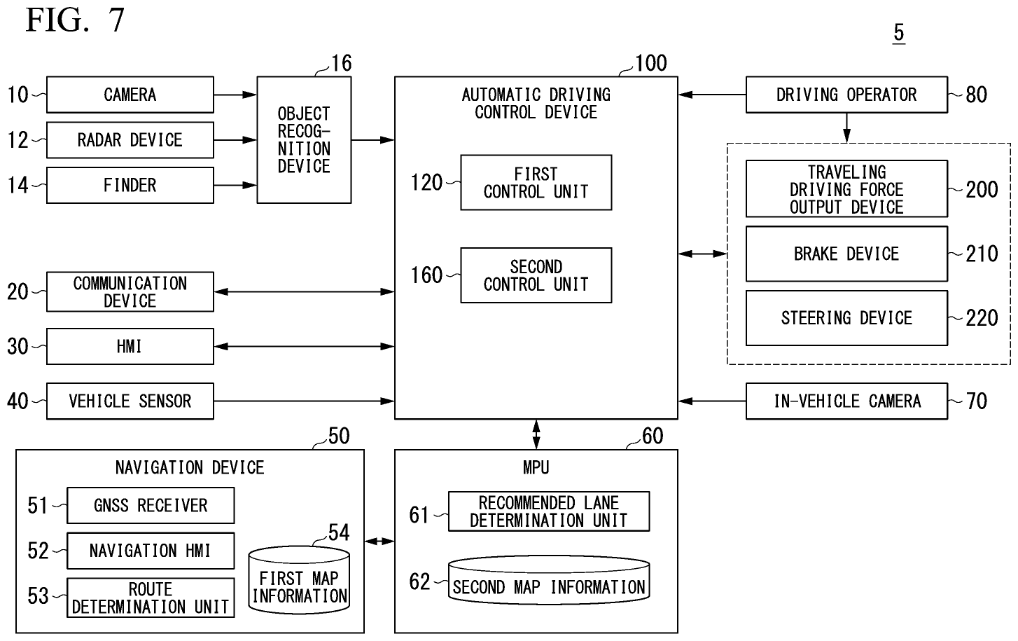

Next, the vehicle control device 5 will be described. FIG. 7 is a configuration diagram of the vehicle control device 5 according to the embodiment. A vehicle having the vehicle control device 5 mounted therein is a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a generator connected to the internal combustion engine or electric power discharged from a secondary battery or a fuel cell.

The vehicle control device 5 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, an in-vehicle camera 70, a driving operator 80, an automatic driving control device 100, a traveling driving force output device 200, a brake device 210, and a steering device 220. These devices and apparatuses are connected to each other through a multi communication line such as a controller area network (CAN) communication line, a serial communication line, a wireless communication network, or the like. Components shown in FIG. 7 are merely examples, and some of the components may be omitted, or other components may be further added.

The camera 10 is a digital camera using a solid-state image sensing device such as a charge coupled device (CCD) or a complementary metal oxide semiconductor (CMOS). The camera 10 is attached to any location on an automatic driving vehicle in which the vehicle control device 5 is mounted. In a case where the camera 10 images a side in front, the camera 10 is attached to an upper portion of a front wind shield, a back surface of an interior mirror, or the like. The camera 10 repeatedly images, for example, the surroundings of the automatic driving vehicle on a periodic basis. The camera 10 may be a stereo camera.

The radar device 12 radiates electromagnetic waves such as millimeter waves to the periphery of the automatic driving vehicle and detects radio waves (reflected waves) reflected by an object to detect at least the position (distance and direction) of the object. The radar device 12 is attached to any location on the automatic driving vehicle. The radar device 12 may detect the position and speed of the object by a frequency modulated continuous wave (FM-CW) method.

The finder 14 is a light detection and ranging (LIDAR) device. The finder 14 irradiates the periphery of the automatic driving vehicle with light to measure scattered light. The finder 14 detects a distance to the object on the basis of a time from light emission to light reception. The emitted light is, for example, a pulsed laser beam. The finder 14 is attached to any location on the automatic driving vehicle.

The object recognition device 16 performs sensor fusion processing on detection results obtained by some or all of the camera 10, the radar device 12, and the finder 14 to recognize the position, type, speed, and the like of an object. The object recognition device 16 outputs recognition results to the automatic driving control device 100. The object recognition device 16 may output detection results of the camera 10, the radar device 12, and the finder 14 to the automatic driving control device 100 as they are. The object recognition device 16 may be omitted from the vehicle control device 5.

The communication device 20 communicates with other vehicles in the vicinity of an automatic driving vehicle using, for example, a cellular network, a Wi-Fi network, Bluetooth (registered trademark), dedicated short range communication (DSRC), or the like or communicates with various server devices through a wireless base station.

The HMI 30 presents various information to an occupant of an automatic driving vehicle and receives an operation which is input by the occupant. The HMI 30 includes various display devices, a speaker, a buzzer, a touch panel, a switch, a key, and the like.

The vehicle sensor 40 includes a vehicle speed sensor that detects the speed of an automatic driving vehicle, an acceleration sensor that detects an acceleration, a yaw rate sensor that detects an angular velocity around a vertical axis, a direction sensor that detects the direction of the automatic driving vehicle, and the like.

The navigation device 50 includes, for example, a global navigation satellite system (GNSS) receiver 51, a navigation HMI 52, and a route determination unit 53. The navigation device 50 stores first map information 54 in a storage device such as an HDD or a flash memory. The GNSS receiver 51 identifies the position of an automatic driving vehicle on the basis of signals received from GNSS satellites. The position of the automatic driving vehicle may be identified or complemented by an inertial navigation system (INS) using an output of the vehicle sensor 40. The navigation HMI 52 includes a display device, a speaker, a touch panel, a key, and the like. The navigation HMI 52 may be partially or wholly shared with the HMI 30 mentioned above. The route determination unit 53 determines, for example, a route (hereinafter, a route on a map) from the position of an automatic driving vehicle identified by the GNSS receiver 51 (or any input position) to a destination which is input by an occupant using the navigation HMI 52, with reference to the first map information 54. The first map information 54 is, for example, information in which a road shape is expressed by a link indicating a road and nodes connected to each other through the link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be realized by a function of a terminal device such as a smartphone or a tablet terminal owned by an occupant. The navigation device 50 may transmit the current position and a destination to a navigation server through the communication device 20 and may acquire the same route as the route on the map from the navigation server.

The MPU 60 includes, for example, a recommended lane determination unit 61 and stores second map information 62 in a storage device such as an HDD or a flash memory. The recommended lane determination unit 61 divides the route on the map provided from the navigation device 50 into a plurality of blocks (for example, may divide the route on the map every 100 [m] in a vehicle moving direction) and determines a recommended lane for each block with reference to the second map information 62. The recommended lane determination unit 61 performs determination for determining on which lane numbered from the left to travel.

In a case where there is a branch location on the route on the map, the recommended lane determination unit 61 determines a recommended lane so that an automatic driving vehicle can travel on a reasonable route for advancing to a branch destination.

The second map information 62 is more accurate map information than the first map information 54. The second map information 62 includes, for example, information of the center of a lane, information of a boundary of a lane, and the like. The second map information 62 may include, road information, traffic regulation information, address information (an address and a postal code), facility information, telephone number information, and the like. The second map information 62 may be updated at any time by the communication device 20 communicating with other devices.

The in-vehicle camera 70 is a digital camera using a solid-state image sensing device such as a CCD or a CMOS. The in-vehicle camera 70 is attached to any location for imaging the inside of an automatic driving vehicle.

The driving operator 80 includes, for example, an accelerator pedal, a brake pedal, a shift lever, a steering wheel, a deformed steering, a joystick, and other operators. A sensor that detects an operation amount or whether or not an operation has been performed is attached to the driving operator 80, and detection results thereof are output to the automatic driving control device 100 or some or all of the traveling driving force output device 200, the brake device 210, and the steering device 220.

The automatic driving control device 100 includes, for example, a first control unit 120 and a second control unit 160. Each of the first control unit 120 and the second control unit 160 is realized by a hardware processor such as a CPU executing programs (software). Some or all of these components may be realized by hardware (a circuit unit; circuitry is included) such as an LSI, an ASIC, an FPGA, or a GPU, or may be realized by cooperation of software and hardware. The programs may be stored in a storage unit such as an HDD or a flash memory of the automatic driving control device 100 in advance, may be stored in a detachable storage medium such as a DVD or a CD-ROM, or may be installed in the HDD or the flash memory of the automatic driving control device 100 by a storage medium being mounted on a drive device.

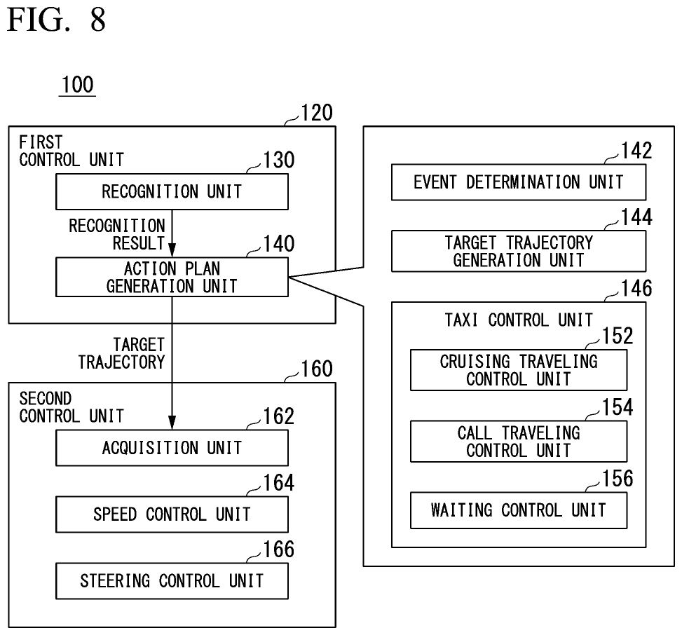

FIG. 8 is a functional configuration diagram of the first control unit 120 and the second control unit 160. The first control unit 120 includes, for example, a recognition unit 130 and an action plan generation unit 140. The first control unit 120 realizes, for example, a function using an artificial intelligence (AI) and a function using a model given in advance in parallel. For example, a function of “recognizing an intersection” is executed by the recognition of the intersection through deep learning or the like and recognition based on conditions given in advance (including a signal applicable to pattern matching, a road sign, and the like) in parallel, and may be realized by scoring both the recognitions and evaluating them comprehensively. Thereby, the reliability of automatic driving is secured.

The recognition unit 130 recognizes states such as the position, speed, and acceleration of an object which is in the vicinity of an automatic driving vehicle, on the basis of information input from the camera 10, the radar device 12, and the finder 14 through the object recognition device 16. The position of the object is recognized as, for example, a position on absolute coordinates with a representative point (the center of gravity, the center of a drive axis, or the like) of an automatic driving vehicle as a starting point and used for control. The position of the object may be represented by a representative point such as the center of gravity or the corner of the object or may be represented as a representative region. The “states” of the object may include the acceleration or jerk of the object, or an “action state” (for example, whether or not the object is changing lane or is attempting to change lane).

The recognition unit 130 recognizes, for example, a lane (traveling lane) in which an automatic driving vehicle is traveling. For example, the recognition unit 130 recognizes a traveling lane by comparing a pattern of road division lines (for example, an array of solid lines and dashed lines) obtained from the second map information 62 and a pattern of road division lines around the automatic driving vehicle recognized from an image captured by the camera 10. The invention is not limited to a road division line, and the recognition unit 130 may recognize a traveling lane by recognizing a traveling road boundary (road boundary) including a road division line, a road shoulder, a curb, a median strip, a guardrail, and the like. In this recognition, the position of the automatic driving vehicle which is acquired from the navigation device 50 and processing results obtained using an INS may be added. The recognition unit 130 recognizes stop lines, obstacles, red traffic lights, toll gates, and other road events.

The recognition unit 130 recognizes the position and posture of the automatic driving vehicle with respect to a traveling lane at the time of recognizing the traveling lane. The recognition unit 130 may recognize, for example, a deviation of a reference point on the automatic driving vehicle from the center of a lane and an angle formed with respect to a line connecting along the center of the lane in a traveling direction of the automatic driving vehicle as a relative position and posture of the automatic driving vehicle with respect to the traveling lane. Alternatively, the recognition unit 130 may recognize the position of a reference point on the automatic driving vehicle with respect to any side end portion (a road division line or a road boundary) of the traveling lane, and the like as a relative position of the automatic driving vehicle with respect to the traveling lane.

The action plan generation unit 140 includes, for example, an event determination unit 142, a target trajectory generation unit 144, and a taxi control unit 146. The event determination unit 142 determines an event of automatic driving in a route for which a recommended lane is determined. The event is information in which a traveling mode of the automatic driving vehicle is specified. Examples of the event of automatic driving include a constant speed traveling event, a low speed following traveling event, a lane change event, a branching event, a joining event, a takeover event, and the like.

The event determination unit 142 may change an event determined in advance to other events or newly determine an event in accordance with surrounding situations recognized by the recognition unit 130 when the automatic driving vehicle is traveling. The event determination unit 142 may determine the level of automatic driving in accordance with which event is being executed, and may output the determined level of automatic driving to the taxi control unit 146.

The target trajectory generation unit 144 generates a future target trajectory for causing an automatic driving vehicle to automatically (without depending on a driver's operation) travel in a traveling mode specified by an event in order for the automatic driving vehicle to basically travel in a recommended lane determined by the recommended lane determination unit 61 and cope with surrounding situations when the automatic driving vehicle travels in the recommended lane. The target trajectory includes, for example, position elements by which the position of a future automatic driving vehicle has been determined and speed elements by which the speed of the future automatic driving vehicle, and the like have been determined. For example, the target trajectory generation unit 144 generates a target trajectory corresponding to an event started by the event determination unit 142.

For example, the target trajectory generation unit 144 determines a plurality of locations (trajectory points) at which the automatic driving vehicles should arrive in order as the position elements of the target trajectory. The trajectory points are spots at which the automatic driving vehicle should arrive at each of predetermined traveling distances (for example, approximately every several [m]). The predetermined traveling distance may be calculated using, for example, a distance along a road when the automatic driving vehicle advances along a route.

The target trajectory generation unit 144 determines a target speed and a target acceleration for each predetermined sampling time (for example, approximately every several fractions of a [sec]) as the speed elements of the target trajectory. The trajectory point may be a position at which the automatic driving vehicle should arrive at a sampling time for each predetermined sampling time. In this case, the target speed and the target acceleration are determined in accordance with a period of sampling time and intervals between trajectory points. The target trajectory generation unit 144 outputs information indicating the generated target trajectory to the second control unit 160.

The taxi control unit 146 causes an automatic driving vehicle to travel as a taxi in a taxi traveling period instructed by the management device 500 and causes the automatic driving vehicle to travel so that the automatic driving vehicle returns by a termination time of the taxi traveling period. For example, the taxi control unit 146 causes the automatic driving vehicle to travel as a taxi in response to an instruction received by the management device 500. For example, the taxi control unit 146 instructs the navigation device 50 to determine a route to a destination on the basis of, for example, a traveling plan received from the management device 500. Thereby, the MPU 60 determines a recommended lane, the event determination unit 142 determines an event, or the target trajectory generation unit 1444 generates a target trajectory. The second control unit 160 controls each device on the basis of information output from the first control unit 120 through such processing, so that the automatic driving vehicle can travel on the basis of the traveling plan.

The taxi control unit 146 monitors whether or not a taxi termination time received from the management device 500 has arrived, on the basis of the taxi termination time. In a case where the taxi termination time has arrived (just at that time or when the time has passed, and the same applies hereinafter), the taxi control unit 146 terminates the traveling of the automatic driving vehicle as a taxi and causes the automatic driving vehicle to travel toward a return point.

The taxi control unit 146 causes an automatic driving vehicle to travel in accordance with a traveling plan instructed by the management device 500. For example, the taxi control unit 146 causes the automatic driving vehicle to travel as a cruising taxi until a call from a customer is made and causes the automatic driving vehicle to travel as a call taxi in a case where a call from a customer has been made. In a case where a period of time in which customers are not engaged in a situation where the automatic driving vehicle is traveling as a cruising taxi is equal to or greater than a predetermined period, the taxi control unit 146 may temporarily terminate the traveling of the automatic driving vehicle as a taxi and park the automatic driving vehicle in a parking lot by a return time.

The taxi control unit 146 includes a cruising traveling control unit 152, a call traveling control unit 154, and a waiting control unit 156.

The cruising traveling control unit 152 performs various processing for causing an automatic driving vehicle to travel as a cruising taxi. For example, the cruising traveling control unit 152 performs processing for visually giving notice of being a taxi when viewed from outside of the automatic driving vehicle (hereinafter, notification processing). The notification processing includes, for example, processing for displaying details on a display board for displaying that a car is empty or the like, and displaying “TAXI”. The cruising traveling control unit 152 performs processing for detecting a person who is raising his or her hand in front of the vehicle, on the basis of recognition results obtained by the object recognition device 16. In a case where the cruising traveling control unit 152 has detected a person who is raising his or her hand, the cruising traveling control unit stops an automatic driving vehicle in the vicinity of the person to perform boarding confirmation processing. The boarding confirmation processing includes, for example, confirming that the number of occupants does not exceed a fixed number for a vehicle, confirming that a destination designated by an occupant does not exceed an allowable range, and the like. The cruising traveling control unit 152 performs billing processing on the traveling of an automatic driving vehicle as a taxi. The billing processing includes deriving a traveling fare corresponding to a traveling distance and displaying the derived traveling fare on, for example, the HMI 30. The cruising traveling control unit 152 performs adjustment processing in a case where an automatic driving vehicle has arrived at a destination. The adjustment processing is processing for receiving electronic money equivalent to a fare derived through the billing processing. The cruising traveling control unit 152 performs locking processing or unlocking processing of an automatic driving vehicle. For example, the cruising traveling control unit 152 performs locking in a case where boarding has been permitted in the boarding confirmation processing, and performs unlocking in a case where a fare has been able to be received through the adjustment processing.

The call traveling control unit 154 performs various processing for causing an automatic driving vehicle to travel as a call taxi. For example, the call traveling control unit 154 executes the above-described notification processing and displays that, for example, the vehicle is a pickup vehicle when going to pick up a customer. The call traveling control unit 154 performs the above-described boarding confirmation processing, billing processing, adjustment processing, and the like. In the boarding confirmation processing, the call traveling control unit 154 may determine whether or not reservation details match or may automatically set a destination in accordance with the reservation contents. The call traveling control unit 154 causes an automatic driving vehicle to travel to an appointment location for a customer on the basis of a vehicle allocation request received from the customer, confirms that the customer has boarded the vehicle through the boarding confirmation processing, and then executes processing for causing the automatic driving vehicle to travel to a destination desired by the customer.

The waiting control unit 156 executes parking lot processing for retrieving a surrounding parking lot, causing an automatic driving vehicle to travel toward the parking lot obtained through the retrieval, and parking the automatic driving vehicle in the parking lot. For example, the waiting control unit 156 executes the parking lot processing in a case where a period in which the automatic driving vehicle cannot continuously pick up a customer (a period in which a customer is not caught) in a situation where the automatic driving vehicle is traveling as a cruising taxi exceeds a third threshold value. The waiting control unit 156 may compare a parking lot fee generated in a case where the automatic driving vehicle is parked until a taxi termination time with a traveling cost incurred in a case where the automatic driving vehicle travels until the taxi termination time and parking lot processing may be executed when the parking lot fee is cheaper than the traveling cost.

The second control unit 160 controls the traveling driving force output device 200, the brake device 210, and the steering device 220 such that an automatic driving vehicle passes along a target trajectory generated by the action plan generation unit 140 at scheduled times.

Referring back to FIG. 2, the second control unit 160 includes, for example, an acquisition unit 162, a speed control unit 164, and a steering control unit 166. The acquisition unit 162 acquires information of the target trajectory (trajectory points) generated by the action plan generation unit 140 and stores the acquired information in a memory (not shown). The speed control unit 164 controls the traveling driving force output device 200 or the brake device 210 on the basis of speed elements accompanying the target trajectory stored in the memory. The steering control unit 166 controls the steering device 220 in accordance with bending conditions of the target trajectory stored in the memory. The processing of the speed control unit 164 and the processing of the steering control unit 166 are realized by, for example, a combination of feedforward control and feedback control. As an example, the steering control unit 166 executes a combination of feedforward control according to a curvature of a road in front of the automatic driving vehicle and feedback control based on a deviation from the target trajectory.

The traveling driving force output device 200 outputs a traveling driving force (torque) for making a vehicle travel to driving wheels. The traveling driving force output device 200 includes, for example, a combination of an internal-combustion engine, an electric motor, and a gearbox, and an ECU that controls these devices. The ECU controls the above-described components in accordance with information which is input from the second control unit 160 or information which is input from the driving operator 80.

The brake device 210 includes, for example, a brake caliper, a cylinder that transmits oil pressure to the brake caliper, an electric motor that generates oil pressure in the cylinder, and a brake ECU. The brake ECU controls the electric motor in accordance with information which is input from the second control unit 160 or information which is input from the driving operator 80 so that a brake torque generated through a braking operation is output to wheels. The brake device 210 may include a mechanism that transmits oil pressure generated by the operation of the brake pedal included in the driving operator 80 to the cylinder through a master cylinder, as a backup. The invention is not limited to the above-described configuration, and the brake device 210 may be an electronic control oil pressure brake device that controls an actuator in accordance with information which is input from the second control unit 160 to transmit oil pressure of the master cylinder to the cylinder.

The steering device 220 includes, for example, a steering ECU and an electric motor.

For example the electric motor changes directions of steering wheels by applying a force to a rack and pinion mechanism. The steering ECU drives the electric motor in accordance with information which is input from the second control unit 160 or information which is input from the driving operator 80 to change the directions of the steering wheels.

[Sequence Diagram]

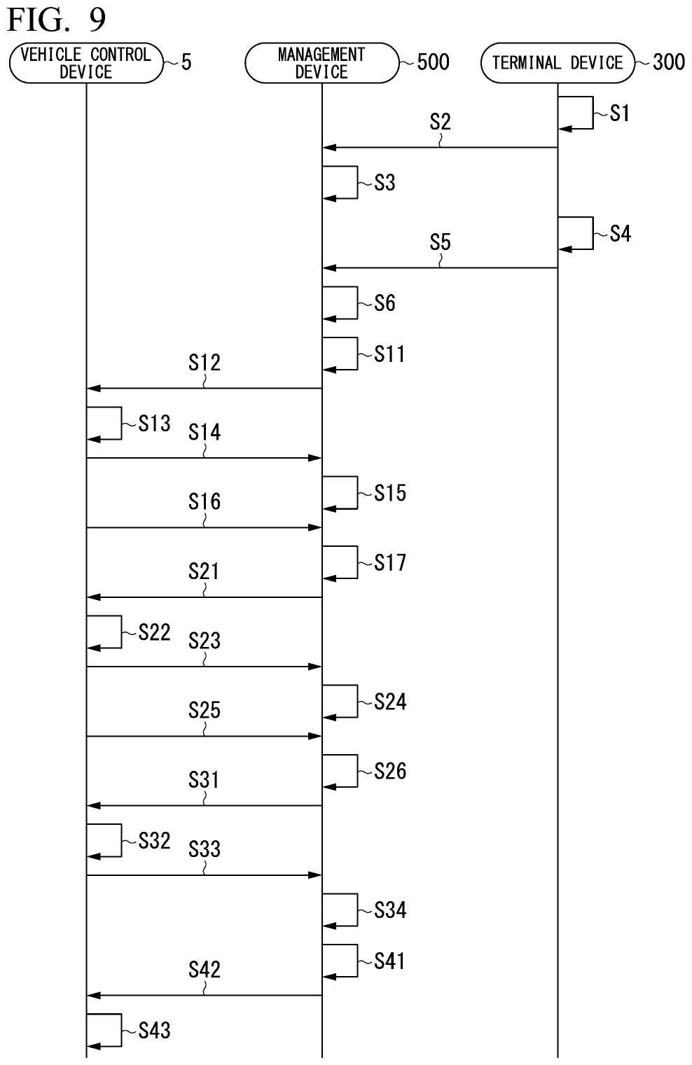

Hereinafter, a flow of a series of processes performed by the vehicle control system 1 of the embodiment will be described using a sequence diagram. FIG. 9 is a sequence diagram indicating an example of a flow of a series of processes performed by the vehicle control system 1 of the embodiment. For example, processing in the present sequence diagram may be repeatedly performed at predetermined time intervals.

First, the owner X inputs a usage schedule of an automatic driving vehicle using the terminal device 300 (step S1). The terminal device 300 transmits information indicating the use schedule of the automatic driving vehicle to the management device 500 through the network NW on the basis of an operation of the owner X (step S2). The management device 500 updates the schedule information 532 of the storage unit 530 on the basis of the received information (step S3).

The owner X inputs taxi traveling conditions for the automatic driving vehicle using the terminal device 300 (step S4). The terminal device 300 transmits information indicating the taxi traveling conditions to the management device 500 through the network NW on the basis of an operation of the owner X (step S5). The management device 500 updates the taxi traveling condition information 534 of the storage unit 530 on the basis of the received information (step S6).

Subsequently, the management device 500 determines a taxi traveling period (step S11). In a case where a starting time of the taxi traveling period has arrived, the management device 500 instructs the automatic driving vehicle to travel according to a traveling plan. For example, the management device 500 instructs the vehicle control device 5 to cause the automatic driving vehicle to travel as a cruising taxi (step S12). In addition, the vehicle control device 5 performs various processing for causing the automatic driving vehicle to travel as a cruising taxi (step S13). In a case where the automatic driving vehicle has picked up a customer in the middle of traveling as a cruising taxi, the vehicle control device 5 notifies the management device 500 that it has picked up a customer (step S14). The management device 500 updates the vehicle status information 538 of the storage unit 530 on the basis of information received from the vehicle control device 5 (step S15). In a case where the automatic driving vehicle has dropped off the customer at a destination, the vehicle control device 5 notifies the management device 500 that it has dropped off the customer (step S16). The management device 500 updates the vehicle status information 538 of the storage unit 530 on the basis of information received from the vehicle control device 5 (step S17).

In a case where the management device 500 has received a vehicle allocation request from a customer (including both a case where the vehicle allocation request has been directly received from a terminal device of the customer and a case where the vehicle allocation request has been received through the taxi server 700), the management device instructs the vehicle control device 5 to cause an automatic driving vehicle to travel as a call taxi (step S21). The vehicle control device 5 performs various processing for causing the automatic driving vehicle to travel as a call taxi (step S22). In a case where the automatic driving vehicle has picked up a customer at a call point, the vehicle control device 5 notifies the management device 500 that it has picked up the customer (step S23). The management device 500 updates the vehicle status information 538 of the storage unit 530 on the basis of information received from the vehicle control device 5 (step S24). Subsequently, in a case where the automatic driving vehicle has dropped off the customer, the vehicle control device 5 notifies the management device 500 that it has dropped off the customer (step S25). The management device 500 updates the vehicle status information 538 of the storage unit 530 on the basis of information received from the vehicle control device 5 (step S26).

The management device 500 instructs the vehicle control device 5 to cause the automatic driving vehicle to travel toward a peripheral parking lot and park in the parking lot in a case where predetermined conditions are satisfied (step S31). The vehicle control device 5 causes the automatic driving vehicle to travel toward a parking lot instructed by the management device 500 and park in the parking lot (step S32). In addition, the vehicle control device 5 notifies the management device 500 that the automatic driving vehicle has parked in the instructed parking lot (step S33). The management device 500 updates the vehicle status information 538 of the storage unit 530 on the basis of information received from the vehicle control device 5 (step S34).

The management device 500 derives a taxi termination time (step S41). In a case where the taxi termination time has arrived, the management device 500 instructs the vehicle control device 5 to cause the automatic driving vehicle to terminate traveling as a taxi and travel toward a return point (step S42). The vehicle control device 5 causes the automatic driving vehicle to travel toward the return point in response to the instruction of the management device 500 (step S43).

[Processing Flow]

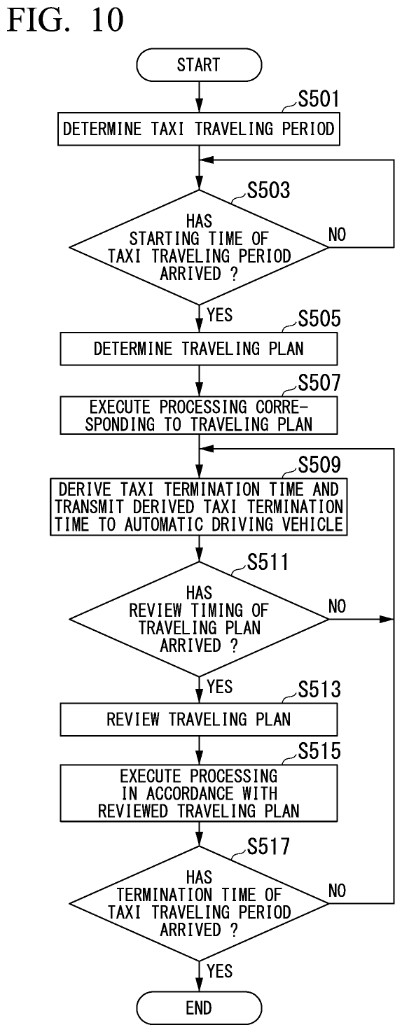

Hereinafter, a flow of processes performed by the management device 500 of the embodiment will be described using a flowchart. FIG. 10 is a flowchart showing a flow of a series of processes performed by the management device 500.

Processing in the present flowchart is performed for each automatic driving vehicle.

First, the taxi traveling determination unit 527 determines a taxi traveling period (step S501). The taxi traveling determination unit 527 determines whether or not a starting time of the taxi traveling period has arrived (step S503). In a case where a starting time of the taxi traveling period has arrived, the taxi traveling determination unit 527 determines a traveling plan (step S505) and executes processing corresponding to the traveling plan (step S507). For example, in a case where a traveling plan in which an automatic driving vehicle first travels as a cruising taxi and then travels as a call taxi in a case where a call has been made is determined as the traveling plan, the taxi traveling determination unit 527 instructs the automatic driving vehicle to travel as a cruising taxi. Subsequently, the taxi traveling determination unit 527 derives a taxi termination time and transmits the derived taxi termination time to the automatic driving vehicle (step S509).

The taxi traveling determination unit 527 determines whether or not a review timing of the traveling plan has arrived (step S511). The review timing of the traveling plan may be set at every predetermined interval, may be a timing at which call information has been created by the vehicle allocation management unit 529, or may be a timing at which it is expected that taxi traveling will not be able to be terminated at the taxi termination time derived in step S509. In a case where the review timing of the traveling plan has arrived, the taxi traveling determination unit 527 reviews the traveling plan (step S513), and executes processing in accordance with the reviewed traveling plan (step S515). Subsequently, the taxi traveling determination unit 527 determines whether or not a termination time of the taxi traveling period has arrived (step S517). The taxi traveling determination unit 527 returns to step S509 to repeat the processing until the termination time of the taxi traveling period arrives. On the other hand, in a case where the termination time of the taxi traveling period has arrived in step S517, the taxi traveling determination unit 527 terminates the processing.

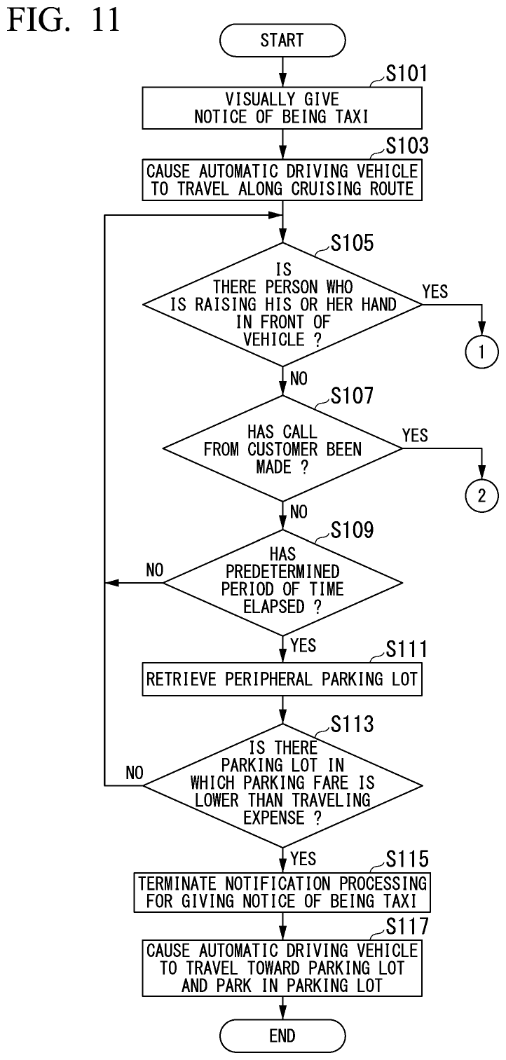

Next, a flow of processes performed by the vehicle control device 5 of the embodiment will be described using a flowchart. FIGS. 11 to 13 are flowcharts showing examples of a flow of processing performed by the taxi control unit 146. The processing in the present flowchart is performed, for example, in a case where the management device 500 has given an instruction for causing an automatic driving vehicle to travel as a taxi.

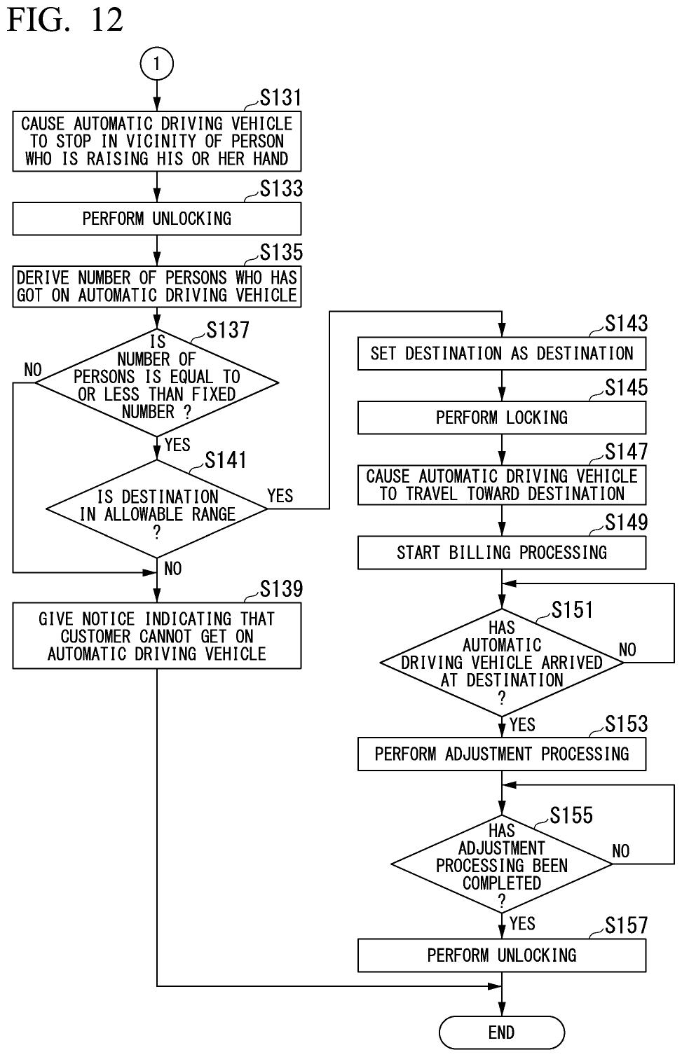

First, the cruising traveling control unit 152 performs notification processing for visually giving notice of being a taxi when viewed from the outside of the automatic driving vehicle (step S101). The cruising traveling control unit 152 causes the automatic driving vehicle to travel along a cruising traveling route in accordance with a traveling plan instructed by the management device 500 (step S103). Subsequently, the cruising traveling control unit 152 determines whether or not a person who is raising his or her hand in front of the vehicle has been detected on the basis of recognition results obtained by the object recognition device 16 (step S105). In a case where a person who is raising his or her hand in front of the vehicle has been detected, the processing proceeds to processing to be described with reference to FIG. 12.

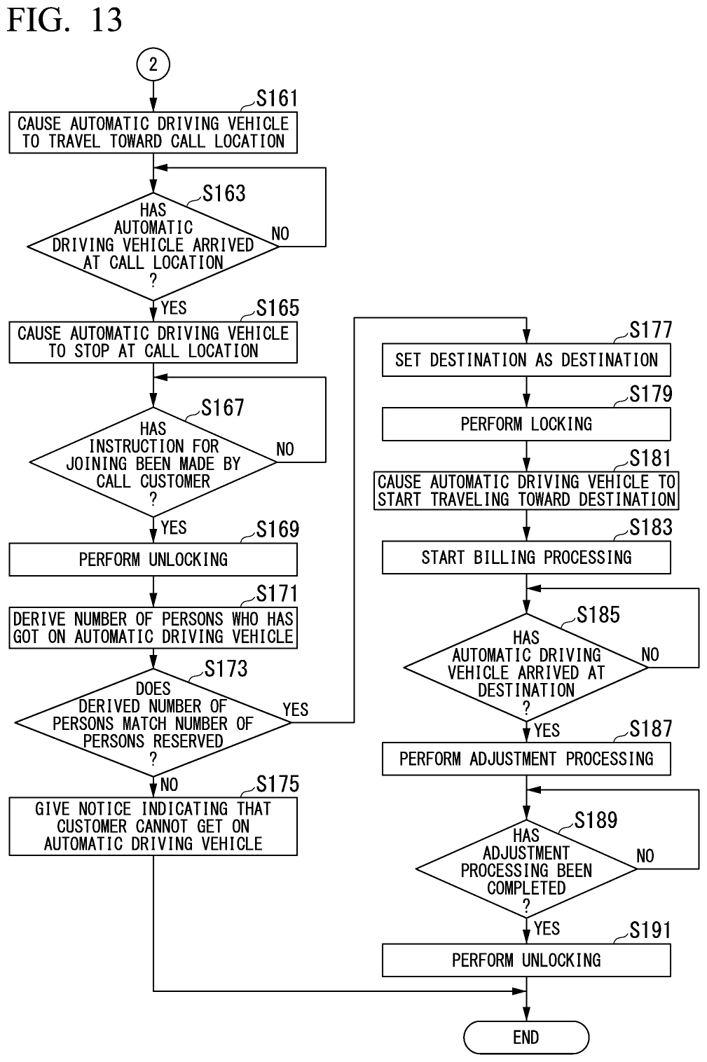

On the other hand, in a case where a person who is raising his or her hand has not been detected in step S105, the taxi control unit 146 determines whether or not a call from a customer has been made (step S107). For example, the taxi control unit 146 determines whether or not call information has been received from the management device 500. The taxi control unit 146 may communicate with a terminal device of the customer and directly receive call information. In a case where a call from the customer has been made, the processing proceeds to processing to be described with reference to FIG. 13.

On the other hand, in a case where a call from the customer has been made in step S107, the taxi control unit 146 determines whether or not a predetermined period of time has elapsed since a point in time when the process of step S101 has started (step S109). In a case where a predetermined period of time has not elapsed, the taxi control unit 146 returns to step S105 to repeat the processing.

On the other hand, in a case where a predetermined period of time has elapsed in step S109, the waiting control unit 156 retrieves one or more parking lots in the vicinity of the automatic driving vehicle with reference to the storage unit 530 (step S111). Subsequently, the waiting control unit 156 derives a parking fare in a case where the automatic driving vehicle has parked in one or more parking lots obtained through the retrieval by a taxi termination time and a traveling expense in a case where the automatic driving vehicle has traveled as a cruising taxi by the taxi termination time, and compares the parking fare and the traveling expense with each other (step S113). In a case where a parking lot in which a parking fare is lower than a traveling expense is not included in retrieval results, the taxi control unit 146 returns to step S105 to repeat the processing.

On the other hand, in a case where a parking lot in which a parking fare is lower than a traveling expense is included in retrieval results in step S113, the waiting control unit 156 terminates the notification processing for giving notice of being a taxi (step S115) and causes the automatic driving vehicle to travel toward the parking lot and park in the parking lot (step S117).

Next, processing executed in a case where a person raising his or her hand in front of a vehicle has been detected in step S105 in the processing of FIG. 11 will be described with reference to FIG. 12. The cruising traveling control unit 152 causes the automatic driving vehicle to stop in the vicinity of the detected person who is raising his or her hand (step S131) and unlocks a key of a door (step S133). Thereby, a customer can get on the automatic driving vehicle.

Subsequently, the cruising traveling control unit 152 derives the number of persons who has got on the automatic driving vehicle on the basis of an image captured by the in-vehicle camera 70 (step S135). In addition, the cruising traveling control unit 152 determines whether or not the derived number of persons is equal to or less than a fixed number for the automatic driving vehicle (step S137). In a case where the derived number of persons is not equal to or less than the fixed number for the automatic driving vehicle, the cruising traveling control unit 152 gives notice indicating that a customer cannot get on the automatic driving vehicle by using the HMI 30 (step S139).

On the other hand, in a case where the number of persons derived in step S137 is equal to or less than the fixed number for the automatic driving vehicle, the cruising traveling control unit 152 determines whether or not a destination which is set by a customer using the HMI 30 is in an allowable range (step S141). For example, the cruising traveling control unit 152 determines whether or not the automatic driving vehicle can return to a return point which is set by the owner X by a taxi termination time after going to a set destination. The cruising traveling control unit 152 may determine whether or not the destination is within a range specified by an area limitation or whether or not a time at which the automatic driving vehicle can return to the return point after going to the set destination is within the range of a time slot limitation, on the basis of taxi traveling conditions which are set by the owner X in advance. In a case where it is determined in step S141 that the destination set by the customer is not within the allowable range, the cruising traveling control unit 152 gives notice indicating that a customer cannot get on the automatic driving vehicle by using the HMI 30 (step S139).

In a case where it is determined in step S141 that the destination set by the customer is within the allowable range, the cruising traveling control unit 152 sets the destination, which is set by the customer using the HMI 30, as a destination of the navigation device 50 (step S143), and locks a key of a door of the automatic driving vehicle (step S145). In addition, the action plan generation unit 140 causes the automatic driving vehicle to travel toward the destination together with the second control unit 160 (step S147).

Subsequently, the cruising traveling control unit 152 starts billing processing (step S149). For example, the cruising traveling control unit 152 derives a fare corresponding to a traveling distance and displays derivation results on the HMI 30. The cruising traveling control unit 152 determines whether or not the automatic driving vehicle has arrived at the destination (step S151). In a case where the automatic driving vehicle has arrived at the destination, the cruising traveling control unit 152 performs adjustment processing (step S153). The cruising traveling control unit 152 determines whether or not the adjustment processing has been completed (step S155). In a case where the adjustment processing has been completed, the cruising traveling control unit 152 unlocks the key of the door of the automatic driving vehicle (step S157).

Next, processing executed in a case where a call from a customer has been made in step S107 in the processing of FIG. 11 will be described with reference to FIG. 13. The action plan generation unit 140 causes the automatic driving vehicle to travel toward a call location (included in, for example, call information) which is designated by the customer, together with the second control unit 160 (step S161). In a case where the automatic driving vehicle has arrived at the call location (step S163), the second control unit 160 causes the automatic driving vehicle to stop at a road shoulder (step S165).

Subsequently, the call traveling control unit 154 determines whether or not an instruction for joining has been made by a call customer (step S167). For example, the call traveling control unit 154 communicates with a terminal device of the call customer to receive the instruction for joining (reservation information, identification information of a customer, or the like). In a case where an instruction for joining has been made by the call customer (for example, a case where information received from the terminal device of the call customer partially or wholly matches call information stored in the vehicle control device 5), the call traveling control unit 154 unlocks the key of the door of the automatic driving vehicle (step S169). Thereby, the call customer can get on the automatic driving vehicle.

Subsequently, the call traveling control unit 154 derives the number of persons who have boarded the vehicle on the basis of an image captured by the in-vehicle camera 70 (step S171). In addition, the call traveling control unit 154 determines whether or not the derived number of persons matches the number of persons reserved in advance (included in, for example, call information) (step S173). In a case where the derived number of persons does not match the number of persons reserved in advance, the call traveling control unit 154 gives notice indicating that a customer cannot get on the automatic driving vehicle by using the HMI 30 (step S175).

On the other hand, in a case where the number of persons derived in step S173 matches the number of persons reserved in advance, the call traveling control unit 154 sets a destination set in advance (included in, for example, call information) as a destination of the navigation device 50 (step S177) and locks the key of the door of the automatic driving vehicle (step S179). In addition, the action plan generation unit 140 causes the automatic driving vehicle to travel toward the destination together with the second control unit 160 (step S181).

Subsequently, the call traveling control unit 154 starts billing processing (step S183). For example, the call traveling control unit 154 derives a fare corresponding to a traveling distance and displays derivation results on the HMI 30. The call traveling control unit 154 determines whether or not the automatic driving vehicle has arrived at the destination (step S185). In a case where the automatic driving vehicle has arrived at the destination, the call traveling control unit 154 performs adjustment processing (step S187). The call traveling control unit 154 determines whether or not the adjustment processing has been completed (step S189). In a case where the adjustment processing has been completed, the call traveling control unit unlocks the key of the door of the automatic driving vehicle (step S191).

According to the above-described first embodiment, it is possible to cause an automatic driving vehicle to be widely used by users other than an owner by including a reception unit (the HMI 30, the communication device 20, the communication unit 510) and a control unit (the taxi control unit 520 or the taxi control unit 146). The reception unit receives the settings of a use schedule of an automatic driving vehicle by a user. The control unit causes the automatic driving vehicle to travel as a taxi from a starting time of a period in which the user does not use the automatic driving vehicle to a termination time and causes the automatic driving vehicle to travel so that the automatic driving vehicle returns to a location designated by the user by the termination time, with reference to the use schedule received by the reception unit.

[Hardware Configuration]

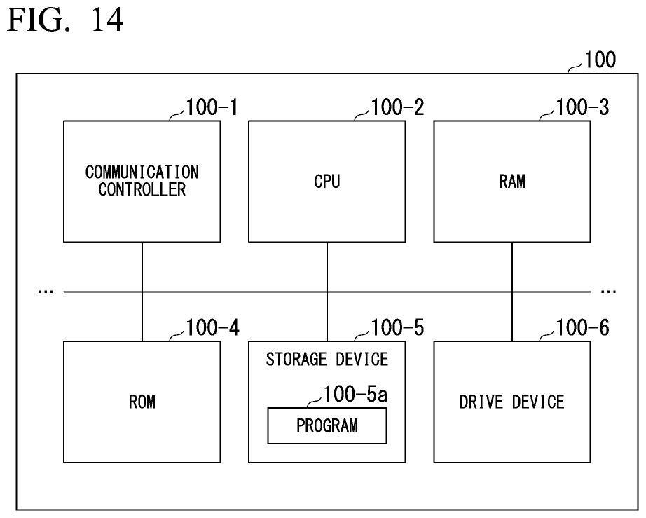

FIG. 14 is a diagram showing an example of a hardware configuration of the automatic driving control device 100 of the embodiment. As shown in the drawing, the automatic driving control device 100 is configured such that a communication controller 100-1, a CPU 100-2, a RAM 100-3 used as a working memory, a ROM 100-4 storing a boot program and the like, a storage device 100-5 such as a flash memory or an HDD, a drive device 100-6, and the like are connected to each other through an internal bus or a dedicated communication line. The communication controller 100-1 communicates with components other than the automatic driving control device 100. A program 100-5a to be executed by the CPU 100-2 is stored in the storage device 100-5. This program is expanded in the RAM 100-3 using a direct memory access (DMA) controller (not shown) or the like and is executed by the CPU 100-2. Thereby, some or all of the first control unit 120 and the second control unit 160 are realized.

While a preferred embodiment of the present invention has been described above, the present invention is not limited to such an embodiment, and various modifications and replacements can be added without departing from the scope of the present invention.

For example, in a case where an automatic driving vehicle travels as a taxi and a case where a location designated by a customer is outside a travelable area, at least one of the management device 500 or the vehicle control device 5 may execute processing for causing a customer to transfer to another automatic driving vehicle traveling as a taxi. The travelable area is, for example, an area free for an area limitation or the like determined in taxi traveling conditions, an area where the automatic driving vehicle can return to a return point by a termination time of a taxi traveling period, or the like. At least one of the management device 500 or the vehicle control device 5 communicates with another vehicle system to request a transfer, and causes the automatic driving vehicle to travel to the location on another automatic driving vehicle for which a transfer has been permitted.

The taxi traveling determination unit 527 may determine a return point of an automatic driving vehicle on the basis of the positional information 536. For example, in a case where the owner X has been moved from a shopping mall on the basis of owner positional information, the taxi traveling determination unit 527 may determine the position of the moved owner X to be a return point.

The taxi traveling determination unit 527 may periodically distribute positional information of a vehicle to the terminal device 300 of the owner X on the basis of the positional information 536.

In a case where the management device 500 has received a request for vehicle allocation from the taxi server 700, the management device transmits the request for vehicle allocation to the owner X. In a case where the owner X has consented to the request, the management device may instruct the vehicle control device 5 to cause an automatic driving vehicle to travel as a taxi even when traveling as a taxi has not been set in a use schedule.

A portion or entirety of the taxi control unit 520 of the management device 500 or a portion or entirety of information stored in the storage unit 530 may be mounted on the vehicle control device 5, and the management device 500 may include a portion or entirety of the taxi control unit 146 included in the vehicle control device 5. That is, at least one of the taxi control unit 520 or the taxi control unit 146 may be included in the “control unit” that causes a taxi to travel in a taxi traveling period and causes an automatic driving vehicle to travel so that the automatic driving vehicle returns to a return point by a termination time of the taxi traveling period.

For example, the vehicle control device 5 may directly receive a vehicle allocation request from a terminal device of a customer without going through the management device 500.

A use schedule of an automatic driving vehicle may be set by the owner X or the like using the HMI 30. The “reception unit” that receives the setting of a use schedule of an automatic driving vehicle by a user includes the HMI 30 that directly receives setting performed by the owner X, the communication device 20 that receives setting performed by the owner X through the network NW and the management device 500, the communication unit 510 that receives setting performed by the owner X through the network NW and the terminal device 300, and the like.

### REFERENCE SIGNS LIST

1 Vehicle control system

5 Vehicle control device

300 Terminal device

500 Management device

700 Taxi server

10 Camera

12 Radar device

14 Finder

16 Object recognition device

20 Communication device

30 HMI

40 Vehicle sensor

50 Navigation device

60 MPU

70 In-vehicle camera

80 Driving operator

100 Automatic driving control device

120 First control unit

130 Recognition unit

140 Action plan generation unit

142 Event determination unit

144 TARGET TRAJECTORY generation unit

146 Taxi control unit

160 Second control unit

162 Acquisition unit

164 Speed control unit

166 Steering control unit

200 Traveling driving force output device

210 Brake device

220 Steering device

510 Communication unit

520 Taxi control unit

520, 530 Storage unit

What is claim is:

1. A vehicle control system comprising:
a reception unit configured to receive setting of a use schedule of an automatic driving vehicle by a user; and
a control unit configured to cause the automatic driving vehicle to travel as a taxi from a starting time to a termination time of a period in which the user does not use the automatic driving vehicle and cause the automatic driving vehicle to travel so that the automatic driving vehicle returns to a location designated by the user by the termination time, with reference to the use schedule received by the reception unit.

2. The vehicle control system according to claim 1, wherein the control unit causes the automatic driving vehicle to travel to an appointment location for a customer on the basis of a vehicle allocation request received by the customer, and causes the automatic driving vehicle to pick up the customer and then travel to a destination desired by the customer.

3. The vehicle control system according to claim 1, wherein the control unit executes billing processing of a traveling fare in a case where the automatic driving vehicle is traveling as a taxi.

4. The vehicle control system according to claim 1, wherein the control unit allocates an automatic driving vehicle matching a vehicle allocation request received by a customer among a plurality of automatic driving vehicles registered in advance, with reference to the use schedule.

5. The vehicle control system according to claim 1, wherein the control unit executes notification processing for visually giving notice indicating that the automatic driving vehicle is traveling as a taxi.

6. The vehicle control system according to claim 1, wherein the control unit creates a most efficient traveling plan on the basis of a fare obtained in a case where the automatic driving vehicle has traveled as a taxi and a fare of energy consumed due to traveling of the automatic driving vehicle.

7. The vehicle control system according to claim 1, wherein the control unit derives a taxi termination time for the automatic driving vehicle to return to a location designated by the user by the termination time in a case where the automatic driving vehicle is traveling as a taxi, and causes the automatic driving vehicle to terminate traveling as a taxi when the taxi termination time has arrived and travel toward the location designated by the user.

8. The vehicle control system according to claim 1, further comprising:
a recognition unit configured to recognize a situation in a vicinity of the automatic driving vehicle,
wherein the control unit detects a customer on the basis of a recognition result obtained by the recognition unit and causes the automatic driving vehicle to stop near the detected customer in a case where the customer has been detected.

9. The vehicle control system according to claim 1, wherein the control unit retrieves a parking space in a case where a period in which the automatic driving vehicle is not able to continuously pick up a customer in a state where the automatic driving vehicle is traveling as a taxi exceeds a threshold value, and causes the automatic driving vehicle to travel toward the parking space obtained through the retrieval.

10. The vehicle control system according to claim 1, wherein the control unit preferentially selects a route in which the automatic driving vehicle is able to travel at a low automatic driving level to cause the automatic driving vehicle to travel.

11. The vehicle control system according to claim 1, wherein the control unit limits a location to be designated by a customer in a case where the automatic driving vehicle travels as a taxi.

12. The vehicle control system according to claim 1, wherein the control unit executes processing for causing a customer to transfer to another vehicle traveling as a taxi in a case where the automatic driving vehicle travels as a taxi and a case where a location designated by the customer is outside an area in which travel is possible.

13. The vehicle control system according to claim 1, wherein the control unit is included in at least one of an in-vehicle device mounted in the automatic driving vehicle or a management device communicating with the in-vehicle device.

14. A vehicle control method comprising:
causing one or more computers to
receive setting of a use schedule of an automatic driving vehicle by a user, and
cause the automatic driving vehicle to travel as a taxi from a starting time to a termination time of a period in which the user does not use the automatic driving vehicle and cause the automatic driving vehicle to travel so that the automatic driving vehicle returns to a location designated by the user by the termination time, with reference to the received use schedule.

15. A computer-readable non-temporary storage medium storing a program causing one or more computers to:
receive setting of a use schedule of an automatic driving vehicle by a user; and
cause the automatic driving vehicle to travel as a taxi from a starting time of a period in which the user does not use the automatic driving vehicle to a termination time and cause the automatic driving vehicle to travel so that the automatic driving vehicle returns to a location designated by the user by the termination time, with reference to the received use schedule.
